(19) United States
(12) Patent Application Publication
(10) Pub. No.: US 2025/0300898 A1
(43) Pub. Date: Sep. 25, 2025

(54) ANOMALY DETERMINATION METHOD, ANOMALY DETERMINATION SYSTEM, AND RECORDING MEDIUM

(71) Applicant: Panasonic Intellectual Property Management Co., Ltd., Osaka (JP)

(72) Inventors: Tatsumi OBA, Chiba (JP); Hiroyuki OKADA, Osaka (JP)

(73) Assignee: Panasonic Intellectual Property Management Co., Ltd., Osaka (JP)

(21) Appl. No.: 19/228,301

(22) Filed: Jun. 4, 2025

Related U.S. Application Data
(63) Continuation of application No. PCT/JP2023/030981, filed on Aug. 28, 2023.
(60) Provisional application No. 63/432,096, filed on Dec. 13, 2022.

(30) Foreign Application Priority Data
Jun. 7, 2023 (JP) 2023-093683

(51) Int. Cl. H04L 41/149; H04L 41/0631; H04L 41/16

(52) U.S. Cl. CPC H04L 41/149; H04L 41/0631; H04L 41/16

(57) ABSTRACT

An anomaly determination method includes: extracting a first communication triplet indicating source device information, destination device information, and type information of a first communication packet that has flowed in a network; calculating, by inputting the first communication triplet into a trained model, a score indicating a probability that the first communication packet is predicted to flow in the network; and determining, using the score calculated, a degree of how anomalous it is for the first communication packet to flow in the network, and outputting the degree determined. The trained model is trained by machine learning to: calculate, as a score, a probability that the first communication triplet is predicted to be present; and have a vector representation representing predetermined two or more devices as vectors closer to each other in a vector space.

### CROSS REFERENCE TO RELATED APPLICATIONS

This is a continuation application of PCT International Application No. PCT/JP2023/030981 filed on Aug. 28, 2023, designating the United States of America, which is based on and claims priority of Japanese Patent Application No. 2023-093683 filed on Jun. 7, 2023 and U.S. Provisional Patent Application No. 63/432,096 filed on Dec. 13, 2022. The entire disclosures of the above-identified applications, including the specifications, drawings and claims are incorporated herein by reference in their entirety.

### FIELD

The present disclosure relates to an anomaly determination method, an anomaly determination system, and a recording medium.

### BACKGROUND

There are industrial control systems (ICSs) for managing and controlling critical infrastructure such as electric power systems and water treatment systems. When ICS networks are built by connecting ICSs to IT system networks or the Internet, the ICS networks may be infected with malware or affected by cyberattacks.

Conventionally, in the ICSs, among network-based security measures, an anomaly detection method that uses a whitelist has been often used in particular (for example, refer to Non Patent Literature (NPL) 1 and 2).

### CITATION LIST

### Non Patent Literature

NPL 1: R. R. R. Barbosa, R. Sadre, and A. Pras, “Flow whitelisting in SCADA networks,” International Journal of Critical Infrastructure Protection (IJCIP), vol. 6, no. 3-4, 2013.
NPL 2: K. Stouffer, J. Falco, and K. Scarfone, “Guide to industrial control systems ICS security,” NIST special publication, vol. 800, no. 82, 2011.
NPL 3: Paxson, V., Campbell, S., & Lee, J. (2006). Bro intrusion detection system (No. Bro; 001905IBMPC00). Lawrence Berkeley National Laboratory.
NPL 4: T. Dettmers, P. Minervini, P. Stenetorp, and S. Riedel, “Convolutional 2d knowledge graph embeddings,” in Proc. of Association for the Advancement of Artificial Intelligence (AAAI), 2018.

### SUMMARY

### Technical Problem

The present disclosure provides an anomaly determination method and so on for appropriately determining an anomaly in communication in a network.

### Solution to Problem

An anomaly determination method according to an aspect of the present disclosure is an anomaly determination method including: extracting a first communication triplet indicating source device information, destination device information, and type information of a first communication packet that has flowed in a network; calculating, by inputting the first communication triplet into a trained model, a score indicating a probability that the first communication packet is predicted to flow in the network; and determining, using the score calculated, a degree of how anomalous it is for the first communication packet to flow in the network, and outputting the degree determined, wherein the trained model is trained by machine learning to: (1) by using a vector representation of source device information or destination device information of a communication packet and type information of the communication packet, calculate, as a score, a probability that the first communication triplet is predicted to be present under presence of a plurality of second communication triplets each indicating a second communication packet that has previously flowed in the network; and (2) make the vector representation a vector representation that represents two or more devices as vectors closer to each other in a vector space, the two or more devices being (i) either source devices or destination devices indicated in the plurality of second communication triplets and (ii) indicated in learning communication triplets having communication partner device information in common and a communication type in common.

Note that these general or specific aspects may be implemented using a system, a device, an integrated circuit, a computer program, a computer-readable recording medium such as a compact disc-read-only memory (CD-ROM), or any combination of systems, devices, integrated circuits, computer programs, and recording media.

### Advantageous Effects

With the anomaly determination method according to the present disclosure, it is possible to appropriately determine an anomaly in communication in a network.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating one example of configurations of an anomaly determination system and a learning device according to an embodiment.

FIG. 2 is a block diagram illustrating one example of configurations of an anomaly determination system and an anomaly determination device according to an embodiment.

FIG. 3 is a diagram illustrating an example of a hardware configuration of a computer.

FIG. 4 is a diagram illustrating an example of communication triplets according to an embodiment.

FIG. 5 is a diagram illustrating an example of learning communication triplets according to an embodiment.

FIG. 6 is a diagram illustrating an example of a multigraph representing learning communication triplets according to an embodiment.

FIG. 7 is a diagram illustrating an example of a target communication triplet according to an embodiment.

FIG. 8 is a diagram illustrating an example of a score calculation result for a target communication triplet according to an embodiment.

FIG. 9 is a diagram illustrating vector representations of devices according to a comparative example.

FIG. 10 is a diagram illustrating vector representations of devices according to an embodiment.

FIG. 11 is a diagram illustrating a framework of a process performed by an anomaly determination system according to an embodiment.

FIG. 12 is a diagram conceptually illustrating one example of a process performed in a preparation phase by an anomaly determination system according to an embodiment.

FIG. 13 is a diagram conceptually illustrating one example of a process performed in a learning phase by an anomaly determination system according to an embodiment.

FIG. 14 is a diagram conceptually illustrating one example of a process performed in a score calculation phase by an anomaly determination system according to an embodiment.

FIG. 15 is a flow diagram illustrating processes performed by an anomaly determination system according to an embodiment.

FIG. 16 is a flow diagram illustrating a learning communication triplet extraction process performed by an anomaly determination system according to an embodiment.

FIG. 17 is a flow diagram illustrating a learning process performed by an anomaly determination system according to an embodiment.

FIG. 18 is a flow diagram illustrating a score calculation process performed by an anomaly determination system according to an embodiment.

FIG. 19 is a diagram illustrating the characteristics of a dataset according to a working example.

FIG. 20 is a diagram illustrating a first example of evaluation values for anomaly detection techniques according to a working example and comparative examples.

FIG. 21 is a diagram illustrating a second example of evaluation values for anomaly detection techniques according to a working example and a comparative example.

### DESCRIPTION OF EMBODIMENTS

### (Underlying Knowledge Forming Basis of the Present Disclosure)

The inventors have found the following problems with regard to the ICSs described in the “Background” section above.

There are industrial control systems (ICSs) for managing and controlling critical infrastructure such as electric power systems and water treatment systems.

Until recently, the ICSs were separated from corporate IT system networks and the Internet and were therefore relatively safe from malware and cyberattacks.

However, recent years have seen an increase in demand for remotely monitoring or remotely operating critical infrastructure and managing big data collected from critical infrastructure. Therefore, more and more ICSs are connected to IT system networks or the Internet as a result of introduction of Internet of things (IoT) to the ICSs; in other words, more and more ICS networks are being built. Consequently, there is an increasing trend in the number of cases where the ICS networks are infected with malware or affected by cyberattacks.

Meanwhile, introducing a security product into a device on the ICS network is difficult; therefore, network-based security measures are predominant in the ICSs. In the ICSs, among the network-based security measures, an anomaly detection method that uses a whitelist is said to be effective in particular and is thus often used (for example, refer to NPL 1 and 2). For example, the whitelist includes three items of information, namely the Internet protocol (IP) address of a server, the port number of transmission control protocol (TCP) or user datagram protocol (UDP), and the IP address of a client (hereinafter referred to as a communication triplet). When a communication triplet that is not included in the whitelist is observed, an alert is issued. In this manner, security measures for the ICSs can be implemented.

The anomaly detection methods disclosed in NPL 1 and 2 are methods in which normal communication triplets are held as a whitelist and a communication triplet that is not included in the whitelist is detected as an anomalous communication triplet. These methods are problematic in that false detection occurs frequently. Security operators need to analyze whether a detected anomalous communication triplet, due to which an alert has been issued, is important in terms of security, for example, whether the detected anomalous communication triplet exposes the ICS network to malware infection or cyberattacks. Therefore, the security operators are forced to deal with a large number of false alerts. In other words, the anomaly detection methods disclosed in NPL 1 and 2 impose heavy analysis burdens on the security operators for the ICS network, and thus it is impractical to apply these methods.

The present disclosure has been conceived in view of the above circumstances, and provides an anomaly determination method and so on for appropriately determining an anomaly in communication in a network.

Hereinafter, the disclosure of the present specification will be described as an example, and advantageous effects etc., obtained from the disclosure will be explained.

(1) An anomaly determination method including: extracting a first communication triplet indicating source device information, destination device information, and type information of a first communication packet that has flowed in a network; calculating, by inputting the first communication triplet into a trained model, a score indicating a probability that the first communication packet is predicted to flow in the network; and determining, using the score calculated, a degree of how anomalous it is for the first communication packet to flow in the network, and outputting the degree determined, wherein the trained model is trained by machine learning to: (1) by using a vector representation of source device information or destination device information of a communication packet and type information of the communication packet, calculate, as a score, a probability that the first communication triplet is predicted to be present under presence of a plurality of second communication triplets each indicating a second communication packet that has previously flowed in the network; and (2) make the vector representation a vector representation that represents two or more devices as vectors closer to each other in a vector space, the two or more devices being (i) either source devices or destination devices indicated in the plurality of second communication triplets and (ii) indicated in learning communication triplets having communication partner device information in common and a communication type in common.

According to the above aspect, in the anomaly determination method, two or more devices (also referred to as similar devices) that are indicated in second communication triplets having communication partner device information in common and the communication type in common are represented as vectors closer to each other in a vector space, and a degree of anomaly of the first communication packet is determined and output using such vector representations, and thus it is possible to appropriately predict the presence of the first communication triplet using the model. As a result, the degree of anomaly of the first communication packet that is output can be a more appropriate value. Accordingly, the anomaly determination method can appropriately determine an anomaly in communication in a network.

(2) The anomaly determination method according to (1), wherein the trained model is a model trained by the machine learning using, as a loss function, a sum of a first function and a second function, the first function includes a loss function included in a link prediction method by which a probability that the first communication triplet is predicted to be present under presence of the plurality of second communication triplets is calculated as a score using machine learning, and the second function includes a sum total of distances between (i) an average vector that is an average of the vectors that represent each of the two or more devices and (ii) each of the vectors that represent each of the two or more devices.

According to the above aspect, the anomaly determination method can appropriately calculate the probability that the first communication triplet is predicted to be present under the presence of the second communication triplets, by using, as a portion of a loss function, the first function that is a loss function included in the link prediction method. Further, by using, as a portion of the loss function, a sum total of distances between (i) an average vector that is an average of the vectors that represent each of similar devices and (ii) each of the vectors that represent each of the two or more devices, it is possible to more easily represent the similar devices as closer vectors in the vector space. Accordingly, the anomaly determination method can appropriately determine an anomaly in communication in a network.

(3) The anomaly determination method according to (2), wherein the loss function denoted by L is expressed as L=L₁+α×L₂, where L₁ denotes the first function, L₂ denotes the second function, and a denotes a hyper parameter.

According to the above aspect, since the anomaly determination method can adjust, using hyper parameter a, the degree of contribution of each of the first function and the second function to the loss function, it is possible to more appropriately determine whether the first communication packet is anomalous. Accordingly, the anomaly determination method can appropriately determine an anomaly in communication in a network.

(4) The anomaly determination method according to (3), wherein the second function denoted by L₂ is expressed as

$$\begin{matrix}[ Math . 1 ] & \\ {L}_{2} = {\sum }_{k = 1}^{K} {\sum }_{i = 1}^{{n}_{k}} {‖ {x}_{k}^{( i )} - {c}_{k} ‖}^{2} \\ where & \\ [ Math . 2 ] & \\ {c}_{k} = \frac{( {x}_{k}^{( 1 )} + ⋯ + {x}_{k}^{( {n}_{k} )} )}{{n}_{k}} & \end{matrix}$$

K denotes a total number of sets of the communication partner device information and the type information, nₖ denotes a total number of devices included in a k-th set among the sets, and

$$\begin{matrix}[ Math . 3 ] & \\ {x}_{k}^{( i )} & \end{matrix}$$

denotes a vector representing an i-th device included in the k-th set.

According to the above aspect, the anomaly determination method can more easily compose a loss function using second function L₂ that includes distances between (i) vectors representing similar devices and (ii) an average vector. By appropriately predicting the presence of the first communication packet using a model trained using the loss function, the anomaly determination method can make the degree of anomaly of the first communication packet a more appropriate value. Accordingly, the anomaly determination method can appropriately determine an anomaly in communication in a network in an easier manner.

(5) The anomaly determination method according to (3), wherein the second function denoted by L₂ is expressed as

$$\begin{matrix}[ Math . 4 ] & \\ {L}_{2} = {\sum }_{k = 1}^{K} {{w}_{k} ( {\sum }_{i = 1}^{{n}_{k}} {‖ {x}_{k}^{( i )} - {c}_{k} ‖}^{p} )}^{\frac{1}{p}} \\ where & \\ [ Math . 5 ] & \\ {c}_{k} = \frac{( {x}_{k}^{( 1 )} + ⋯ + {x}_{k}^{( {n}_{k} )} )}{{n}_{k}} & \end{matrix}$$

K denotes a total number of sets of the communication partner device information and the type information, wₖ denotes a weight value for a k-th set among the sets, nₖ denotes a total number of devices included in the k-th set,

$$\begin{matrix}[ Math . 6 ] & \\ {x}_{k}^{( i )} & \end{matrix}$$

denotes a vector representing an i-th device included in the k-th set, and p denotes an integer greater than or equal to 1.

According to the above aspect, the anomaly determination method can more easily compose a loss function using second function L₂ that includes a weighted sum of p-square sums of distances between (i) vectors representing similar devices and (ii) an average vector. By appropriately predicting the presence of the first communication packet using a model trained using the loss function, the anomaly determination method can make the degree of anomaly of the first communication packet a more appropriate value. Accordingly, the anomaly determination method can appropriately determine an anomaly in communication in a network in an easier manner.

(6) The anomaly determination method according to any one of (2) to (5), wherein the link prediction method is convolutional 2d knowledge graph embeddings (ConvE).

According to the above aspect, the anomaly determination method can appropriately calculate the probability that the first communication triplet is predicted to be present under the presence of the second communication triplets, by using ConvE as the link prediction method. Accordingly, the anomaly determination method can appropriately determine an anomaly in communication in a network.

(7) The anomaly determination method according to (1), wherein the source device information is a source IP address of the communication packet, the destination device information is a destination IP address of the communication packet, and the type information indicates (i) information indicating a transmission control protocol (TCP) or a user datagram protocol (UDP) of the communication packet and (ii) a port number of the communication packet.

According to the above aspect, the anomaly determination method can more easily obtain a communication triplet (specifically a first communication triplet and a second communication triplet) using a source IP address, a destination IP address, and information indicating TCP or UDP and a port number of a communication packet, and determine and output the degree of how anomalous it is for the first communication packet to flow.

(8) An anomaly determination system including: an extractor that extracts a first communication triplet indicating source device information, destination device information, and type information of a first communication packet that has flowed in a network; a calculator that calculates, by inputting the first communication triplet into a trained model, a score indicating a probability that the first communication packet is predicted to flow in the network; and a determiner that determines, using the score calculated by the calculator, a degree of how anomalous it is for the first communication packet to flow in the network, and outputs the degree determined, wherein the trained model is trained by machine learning to: (a) by using a vector representation of source device information or destination device information of a communication packet and type information of the communication packet, calculate, as a score, a probability that the first communication triplet is predicted to be present under presence of a plurality of second communication triplets each indicating a second communication packet that has previously flowed in the network; and (b) make the vector representation a vector representation that represents two or more devices as vectors closer to each other in a vector space, the two or more devices being (i) either source devices or destination devices indicated in the plurality of second communication triplets and (ii) indicated in learning communication triplets having communication partner device information in common and a communication type in common.

According to the above aspect, the same advantageous effects as those produced by the above-described anomaly determination method are produced.

(9) A non-transitory computer-readable recording medium having recorded thereon a program for causing a computer to execute the anomaly determination method according to (1).

According to the above aspect, the same advantageous effects as those produced by the above-described anomaly determination method are produced.

Note that these general or specific aspects may be implemented using a system, a device, an integrated circuit, a computer program, or a computer-readable recording medium such as a CD-ROM, or any combination of systems, devices, integrated circuits, computer programs, or recording media.

Hereinafter, an exemplary embodiment will be specifically described with reference to the drawings.

Note that the exemplary embodiment described below shows a general or specific example. The numerical values, shapes, materials, constituent elements, the arrangement and connection of the constituent elements, steps, the processing order of the steps etc. shown in the exemplary embodiment below are mere examples, and are therefore not to limit the present disclosure. Also, among the constituent elements in the exemplary embodiment described below, those not recited in any one of the independent claims representing the most generic concepts will be described as optional constituent elements.

### Embodiment

In the present embodiment, an anomaly determination method, an anomaly determination device, and so on that appropriately determine an anomaly in communication in a network will be described.

### [1. Anomaly Determination System 100]

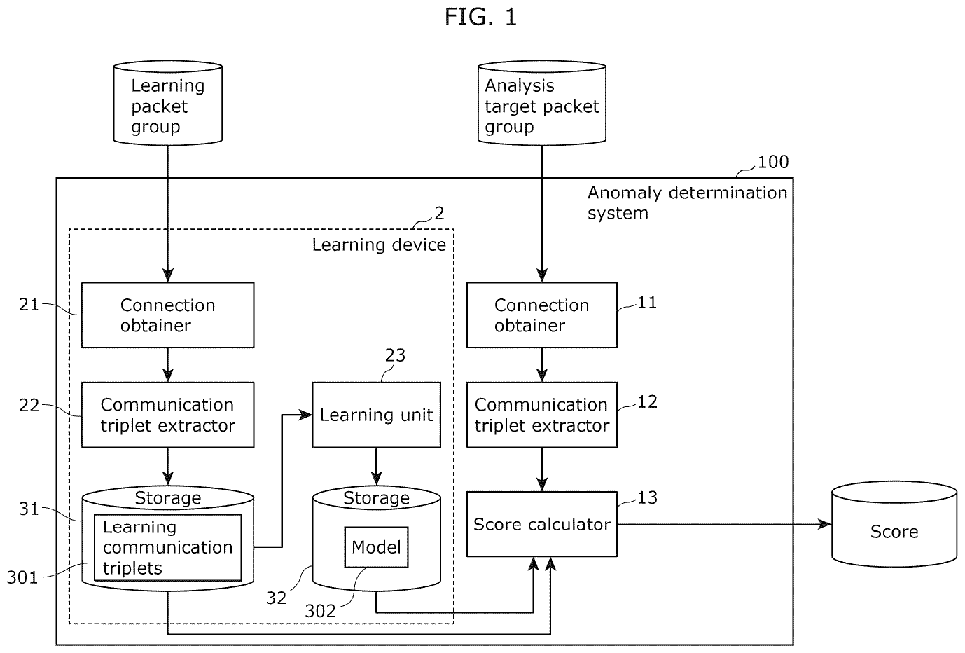

FIG. 1 is a block diagram illustrating one example of configurations of anomaly determination system 100 and learning device 2 according to the present embodiment.

Anomaly determination system 100 is implemented using a computer or the like and, based on information such as a communication triplet of a communication packet (also simply referred to as a packet) included in a learning packet group, performs a score calculation process on a communication triplet of a packet included in an analysis target packet group, and outputs a score. The score herein indicates quantitative representation of the likelihood (in other words, naturalness) that the packet indicated in the communication triplet flows (in other words, emerges) in the network.

The packet included in the analysis target packet group and the packet included in the learning packet group are, for example, packets that have flowed in the network (for example, the ICS network) on which anomaly determination system 100 is to perform anomaly determination. Anomaly determination system 100 may function as a communication monitoring system that monitors communication in a network.

In the present embodiment, anomaly determination system 100 includes, as illustrated in FIG. 1, connection obtainer 11, communication triplet extractor 12, score calculator 13, connection obtainer 21, communication triplet extractor 22, learning unit 23, storage 31, and storage 32.

Connection obtainer 21, communication triplet extractor 22, learning unit 23, storage 31, and storage 32 are functional elements related to learning of communication in a network, and may constitute learning device 2 as illustrated in FIG. 1.

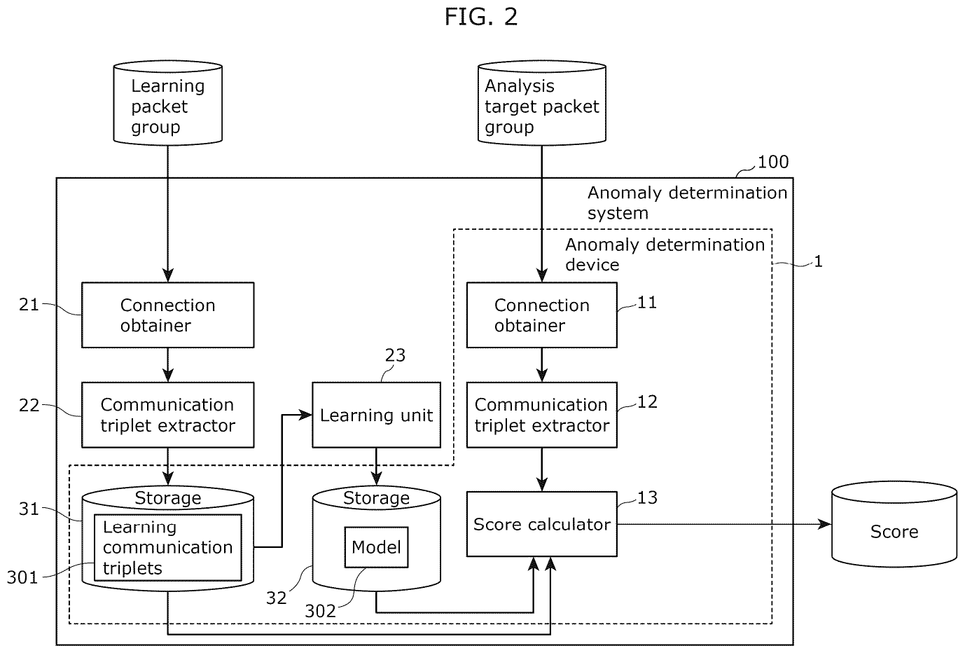

Furthermore, connection obtainer 11, communication triplet extractor 12, score calculator 13, storage 31, and storage 32 are functional elements related to anomaly determination or analysis of communication in a network, and may constitute anomaly determination device 1 as illustrated in FIG. 2.

Hereinafter, anomaly determination device 1 and learning device 2 will be described.

### [1.1 Anomaly Determination Device 1]

FIG. 2 is a block diagram illustrating one example of configurations of anomaly determination system 100 and anomaly determination device 1 according to the present embodiment.

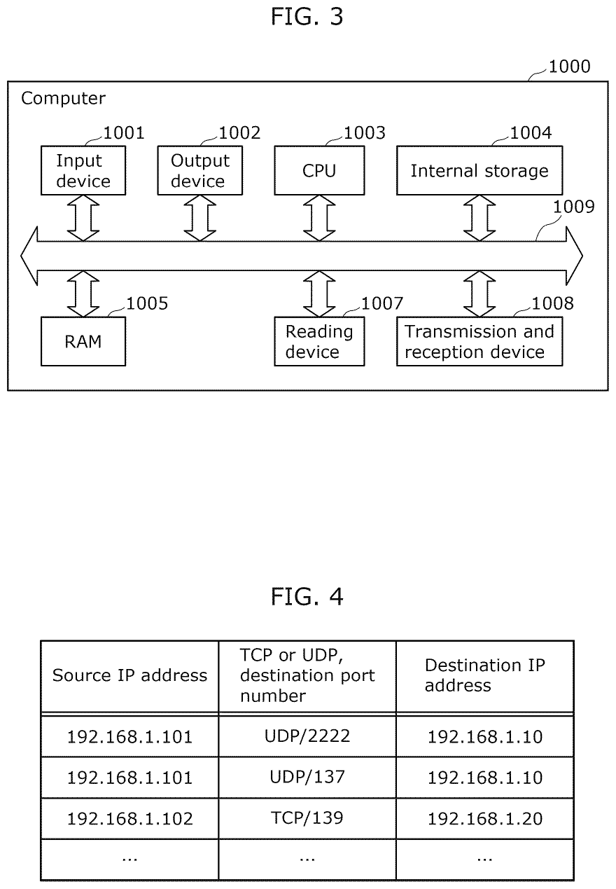

Anomaly determination device 1 is implemented using, for example, computer 1000 illustrated in FIG. 3, and determines an anomaly in communication in a network.

### [1.2 Hardware Configuration of Anomaly Determination Device 1]

FIG. 3 is a diagram illustrating one example of a hardware configuration of computer 1000.

Computer 1000 illustrated in FIG. 3 includes input device 1001, output device 1002, central processing unit (CPU) 1003, internal storage 1004, random-access memory (RAM) 1005, reading device 1007, transmission and reception device 1008, and bus 1009. Input device 1001, output device 1002, CPU 1003, internal storage 1004, RAM 1005, reading device 1007, and transmission and reception device 1008 are connected by bus 1009.

Input device 1001 is a device serving as a user interface such as an input button, a touchpad, or a touch-panel display, and receives user input. Note that input device 1001 may be configured not only to receive user touch input, but also to receive voice control and a remote operation using a remote control or the like.

Internal storage 1004 is a flash memory or the like. At least one of a program for implementing the functions of anomaly determination device 1 or an application in which the functional configuration of anomaly determination device 1 is used may be stored in internal storage 1004 in advance.

RAM 1005 is random-access memory and is used to store data etc., at the time of execution of the program or the application.

Reading device 1007 reads information from a recording medium such as a universal serial bus (USB) memory. From a recording medium on which the aforementioned program or application is recorded, reading device 1007 reads the program or application and stores the program or application in internal storage 1004.

Transmission and reception device 1008 is a communication circuit for performing wired or wireless communication. For example, transmission and reception device 1008 may communicate with a server device or the like connected to a network, download the aforementioned program or application, and store the program or application in internal storage 1004.

CPU 1003 copies the program or application stored in internal storage 1004 onto RAM 1005, and sequentially reads commands included in the program or application from RAM 1005 to execute the commands.

### [1.3 Configuration of Anomaly Determination Device 1]

As illustrated in FIG. 2, anomaly determination device 1 includes connection obtainer 11, communication triplet extractor 12, score calculator 13, storage 31, and storage 32. Hereinafter, these constituent elements will be described.

### [1.3.1 Connection Obtainer 11]

Connection obtainer 11 obtains connection information from an analysis target packet group. The analysis target packet group includes one or more packets that have flowed in the network. The information is information regarding a virtual connection communication path established between software products or devices that perform communication. The connection information is, for example, information indicating from which node (device) to which node (device) a communication path is established and what port is used to establish the communication path.

Connection obtainer 11 can obtain the connection information using the technique disclosed in NPL 3, for example. In that case, connection obtainer 11 can obtain the connection information by obtaining a file called “conn.log”.

### [1.3.2 Communication Triplet Extractor 12]

Communication triplet extractor 12 extracts a communication triplet of the analysis target packet group (also referred to as a target communication triplet or a first communication triplet) from the connection information obtained by connection obtainer 11. The communication triplet is information including: information indicating a source device of a packet that has flowed in the network; information indicating a destination device of the packet; and information indicating the type of the communication (also referred to as a communication type) of the packet.

FIG. 4 is a diagram illustrating an example of communication triplets according to the present embodiment.

As illustrated in FIG. 4, for example, each communication triplet includes three items of information: the source IP address of the packet; information indicating TCP or UDP and the destination port number of the packet; and the destination IP address of the packet. The source IP address is one example of the information indicating a source device. The information indicating TCP or UDP and the destination port number is one example of the information indicating the communication type. The destination IP address is one example of the information indicating a destination device.

Note that the communication triplet is not limited to include three items of information illustrated in FIG. 4, and may include: information that identifies a device such as the media access control (MAC) address of the device or the serial number of the device; the category of information exchanged between devices (for example, the type of a communication command such as write or read, or information indicating a notification or an alert); or a protocol name.

Specifically, in the communication triplet, the information indicating a source device may be the MAC address or the serial number of the source device. Also, the information indicating a destination device may be the MAC address or the serial number of the destination device. Furthermore, the information indicating the communication type may include the category of information exchanged between the source device and the destination device.

### [1.3.3 Storage 31]

Storage 31 includes, for example, rewritable non-volatile memory such as a hard disk drive or a solid-state drive.

In storage 31, a plurality of learning communication triplets 301 (also referred to as second communication triplets) are stored. Each of the plurality of learning communication triplets 301 includes information indicating a source device, information indicating a destination device, and information indicating a communication type.

### [1.3.4 Storage 32]

Storage 32 includes, for example, rewritable non-volatile memory such as a hard disk drive or a solid-state drive.

In storage 32, trained model 302 is stored. Trained model 302 is model 302 which has been trained by learning unit 23 through machine learning (described later).

Note that although storage 31 and storage 32 are separately provided in the examples illustrated in FIG. 1 and FIG. 2, storage 31 and storage 32 may be integrally provided.

Also, storage 31 and storage 32 included in anomaly determination device 1 need not be the same as storage 31 and storage 32 included in learning device 2. In other words, it is sufficient so long as anomaly determination device 1 includes a storage in which learning communication triplets 301 and model 302 are stored, and this storage need not be storage 31 or storage 32.

### [1.3.5 Score Calculator 13]

Score calculator 13 performs a process (also referred to as a score calculation process) of calculating a score indicating the probability that a packet (also referred to as a first communication packet) corresponding to a target communication triplet is predicted to flow in the network. Also, score calculator 13 performs a process (also referred to as a determination process) of determining, using the score calculated, a degree of how anomalous it is for the first communication packet to flow in the network, and outputting the degree determined. The functional element that performs the score calculation process is also referred to as a calculator, and the functional element that performs the determination process is also referred to as a determiner.

The target communication triplet on which the score calculation process is to be performed by score calculator 13 can be, among communication triplets regarding packets included in the analysis target packet group, a communication triplet not included in the plurality of learning communication triplets 301.

Specifically, first, score calculator 13 determines whether the target communication triplet extracted by communication triplet extractor 12 is identical to any of the plurality of learning communication triplets 301 stored in storage 31. Score calculator 13 subsequently performs the score calculation process on the target communication triplet when score calculator 13 determines that the target communication triplet extracted by communication triplet extractor 12 is not identical to any of the plurality of learning communication triplets 301. As the score calculation process, score calculator 13 inputs the target communication triplet into trained model 302 to calculate and output, as a score, a value that quantifies the likelihood that a packet pertaining to the target communication triplet flows in the network. The score calculated indicates that, for example, the higher the value is, the higher the likelihood that the packet pertaining to the communication triplet flows in the network; in other words, the more natural it is for the packet to flow in the network.

As the determination process, score calculator 13 may determine the magnitude of the score calculated for the target communication triplet, by comparing the score with a predetermined threshold. For example, when the score is determined to be less than or equal to the threshold, score calculator 13 may output information indicating that the packet corresponding to the target communication triplet on which the determination process has been performed is anomalous.

For example, in the case where the score calculated can take a positive value, 0, or a negative value, score calculator 13 can determine the magnitude of the score using 0 as the threshold.

On the other hand, the score calculation process for the target communication triplet may be skipped when score calculator 13 determines that the target communication triplet is identical to any of the plurality of learning communication triplets 301 stored in storage 31. This is because, when the target communication triplet is identical to any of the plurality of learning communication triplets 301, the packet pertaining to the target communication triplet can be determined to be normal (in other words, not anomalous).

Note that when the target communication triplet is identical to any of the plurality of learning communication triplets 301, score calculator 13 may output a score indicating that the packet pertaining to the target communication triplet is normal (in other words, not anomalous).

Next, the score calculation process performed on the target communication triplet extracted by communication triplet extractor 12 will be described.

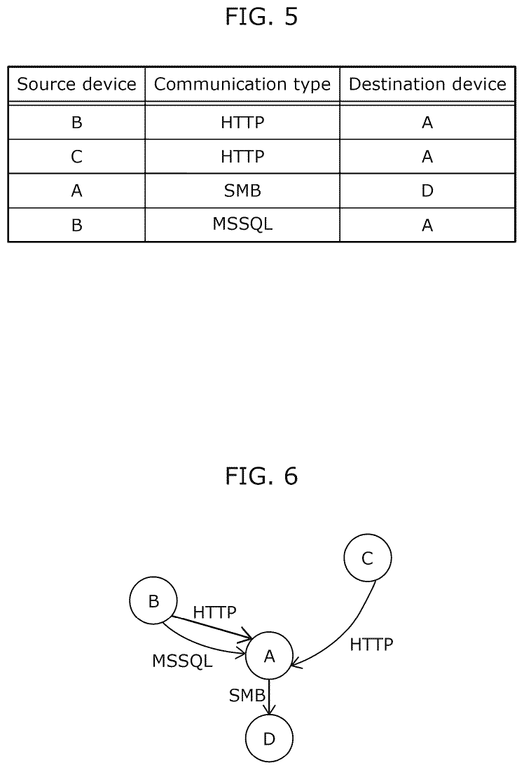

FIG. 5 is a diagram illustrating an example of learning communication triplets according to the present embodiment. FIG. 6 is a diagram illustrating an example of a multigraph of learning communication triplets according to the present embodiment.

The learning communication triplets illustrated in FIG. 5 include four communication triplets each including three items of information, namely a source device, a communication type, and a destination device. For example, the communication triplet shown at the top in FIG. 5 indicates a packet which is from source device B to destination device A and is of a communication type HTTP (hypertext transfer protocol). A communication triplet may be expressed using parentheses such as (a source device, a communication type, and a destination device). For example, the communication triplet shown at the top in FIG. 5 is also expressed as (B, HTTP, A).

The multigraph illustrated in FIG. 6 is a multigraph representing each of the four learning communication triplets illustrated in FIG. 5.

FIG. 6 illustrates nodes A, B, C, and D as nodes respectively corresponding to devices A, B, C, and D that are source devices or destination devices of the learning communication triplets. FIG. 6 also illustrates edges that correspond to communication corresponding to the learning communication triplets, and the communication type of the communication is indicated in the vicinity of each edge. Here, the communication type of communication corresponding to an edge is also referred to as the edge type.

In this case, model 302 has vector representations in a fixed dimension (for example, 128 dimensions or 512 dimensions) corresponding to each node. Score calculator 13 has information for converting a multigraph into vector representations of nodes A, B, C, and D using trained model 302.

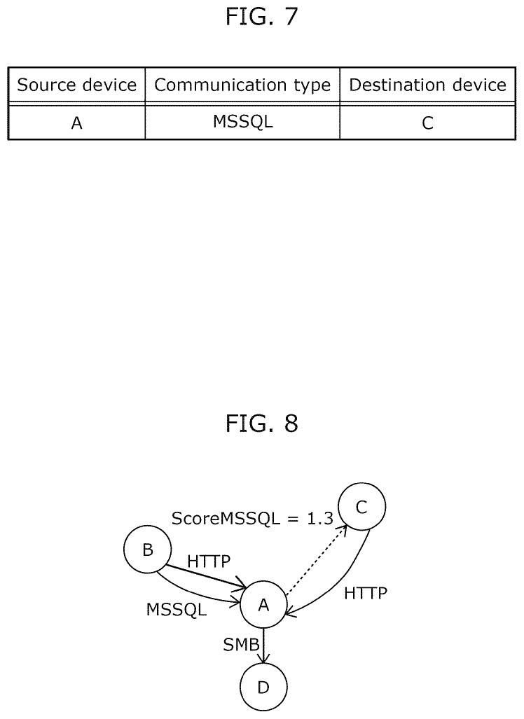

FIG. 7 is a diagram illustrating an example of the target communication triplet according to the present embodiment. FIG. 8 is a diagram illustrating an example of a score calculation result for the target communication triplet according to the present embodiment.

The target communication triplet illustrated in FIG. 7 indicates a packet which is from source device A to destination device C and is of a communication type MSSQL. The packet is expressed as (A, MSSQL, C).

FIG. 8 illustrates a multigraph obtained by adding an edge corresponding to target communication triplet (A, MSSQL, C) to the multigraph illustrated in FIG. 6. FIG. 8 also illustrates an example of the score calculated for target communication triplet (A, MSSQL, C).

Specifically, the edge corresponding to target communication triplet (A, MSSQL, C) is an edge which is from node A to node C and is of the communication type MSSQL. The edge is shown with dashed lines. This is an edge obtained through conversion of target communication triplet (A, MSSQL, C) by score calculator 13.

The score calculated for target communication triplet (A, MSSQL, C) is 1.3. This is a score that score calculator 13 has obtained by quantifying, with use of trained model 302, the likelihood that the edge is present in the network. For example, when the threshold used for determining the magnitude of the score is 0, the score 1.3 calculated for the target communication triplet is greater than 0, and thus score calculator 13 can determine that the target communication triplet is normal (in other words, not anomalous).

### [1.4 Configuration of Learning Device 2]

Next, learning device 2 will be described.

As described above, learning device 2 includes connection obtainer 21, communication triplet extractor 22, learning unit 23, storage 31, and storage 32.

### [1.4.1 Connection Obtainer 21]

Connection obtainer 21 obtains connection information of a learning packet group. The learning packet group includes a plurality of packets that have flowed in the network. More specifically, the learning packet group includes a plurality of packets that have flowed in the network in a predetermined period. The predetermined period is, for example, a period determined in advance as a period in which learning packets are obtained. The predetermined period is typically a period before an analysis target packet group is obtained. The predetermined period can be a period having a length of from several minutes to several weeks, for example.

The method by which connection obtainer 21 obtains connection information is substantially the same as the method by which connection obtainer 11 obtains connection information, and thus the description will be omitted.

### [1.4.2 Communication Triplet Extractor 22]

Communication triplet extractor 22 extracts communication triplets of the learning packet group (also referred to as learning communication triplets or second communication triplets) from the connection information obtained by connection obtainer 21. The method by which communication triplet extractor 22 extracts communication triplets of the learning packet group is substantially the same as the method by which communication triplet extractor 12 extracts a communication triplet of the analysis target packet group.

Note that when some of the communication triplets of the learning packet group overlap one another, communication triplet extractor 22 treats the overlapping communication triplets as one communication triplet. Communication triplet extractor 22 stores the extracted communication triplets in storage 31 as learning communication triplets 301.

### [1.4.3 Storage 31]

Storage 31 includes, for example, rewritable non-volatile memory such as a hard disk drive or a solid-state drive. Learning communication triplets 301 are stored in storage 31. Learning communication triplets 301 stored in storage 31 are used in the score calculation process performed by score calculator 13 as well as in a machine learning process performed by learning unit 23.

### [1.4.4 Storage 32]

Storage 32 includes, for example, rewritable non-volatile memory such as a hard disk drive or a solid-state drive. Model 302 is stored in storage 32. Model 302 is a model trained through the learning process performed by learning unit 23. Model 302 can be a model that is: based on a model of convolutional 2d knowledge graph embeddings (ConvE) (see NPL 4) which is an existing link prediction technique; and trained using a machine learning technique including a loss function that regularizes similar devices.

### [1.4.5 Learning Unit 23]

Learning unit 23 performs, using learning communication triplets 301 stored in storage 31, a learning process on model 302 stored in storage 32. Learning unit 23 updates model 302 stored in storage 32 to trained model 302 by training model 302 through machine learning.

Using learning communication triplets 301 as learning data, learning unit 23 trains model 302 by machine learning to: acquire vector representations of devices indicated in learning communication triplets 301 and vector representations of the type information of learning communication triplets 301; and by using these vector representations, calculate, as a score, the probability that the target communication triplet is predicted to be present under the presence of the plurality of learning communication triplets 301.

More specifically, using three items of information included in each learning communication triplet 301, learning unit 23 constructs a multigraph in which the source device or the destination device is a node and the communication type is the edge type. Furthermore, by inputting the constructed multigraph into model 302, learning unit 23 causes model 302 to acquire the vector representation of the device and the type information by mapping the node and the edge type of the multigraph to the vector representation in a fixed dimension.

Furthermore, learning unit 23 trains model 302 by machine learning to regularize similar devices. Similar devices refer to a relationship of two or more devices that are (i) included in the source devices indicated in the plurality of learning communication triplets 301 and (ii) indicated in learning communication triplets 301 having the destination device information in common and the communication type in common. Regularization of similar devices is a technique of penalizing a situation in which vector representations of two or more devices having a similar device relationship are distant from each other in the vector space, so as to inevitably bring the vector representations of the two or more devices closer to each other.

Note that the destination device information can be used in place of the source device information. In that case, similar devices refer to a relationship of two or more devices that are (i) included in the destination devices indicated in the plurality of learning communication triplets 301 and (ii) indicated in learning communication triplets 301 having the source device information in common and the communication type in common.

That is to say, similar devices can also refer to a relationship of two or more devices that are (i) either source devices or destination devices indicated in the plurality of learning communication triplets 301 and (ii) indicated in learning communication triplets 301 having communication partner device information in common and a communication type in common. Here, the communication partner device information for the source device indicated in a communication triplet is a destination device, whereas the communication partner device information for the destination device indicated in a communication triplet is a source device.

By using, as a loss function for the training using machine learning, a sum of a first function and a second function, learning unit 23 trains model 302 by machine learning to regularize similar devices. The first function includes a loss function included in a link prediction method by which the probability that a first communication triplet is predicted to be present under the presence of a plurality of second communication triplets is calculated as a score using machine learning. The second function includes a sum total of distances each being a distance between (i) a different one of vectors included in a vector group and (ii) the center of the vector group.

More specifically, as loss function L used in the training with machine learning, learning unit 23 uses a sum of first function L₁ and second function L₂ (see Expression 1).

$$L = {L}_{1} + a \times {L}_{2} \qquad Expression 1$$

Here, a denotes a hyper parameter and is appropriately determined at the time of designing model 302.

Second function L₂ is expressed as, for example, Expression 2 below.

$$\begin{matrix}[ Math . 7 ] & \\ {L}_{2} = {\sum }_{k = 1}^{K} {\sum }_{i = 1}^{{n}_{k}} {‖ {x}_{k}^{( i )} - {c}_{k} ‖}^{2} \\ where & Expression 2 \\ [ Math . 8 ] & \\ {c}_{k} = \frac{( {x}_{k}^{( 1 )} + ⋯ + {x}_{k}^{( {n}_{k} )} )}{{n}_{k}} & Expression 3\end{matrix}$$

Here, K denotes a total number of sets of the communication partner device information and the type information. nₖ denotes a total number of devices included in the k-th set among the sets. Also,

$$\begin{matrix}[ Math . 9 ] & \\ {x}_{k}^{( i )} & \end{matrix}$$

denotes a vector representing the i-th device included in the k-th set. cₖ denotes an average vector of vectors included in the k-th set.

Note that, other than the expression shown above, second function L₂ may also be expressed as Expression 4 below.

$$\begin{matrix}[ Math . 10 ] & \\ {L}_{2} = {\sum }_{k = 1}^{K} {{w}_{k} ( {\sum }_{i = 1}^{{n}_{k}} {‖ {x}_{k}^{( i )} - {c}_{k} ‖}^{p} )}^{\frac{1}{p}} & Expression 4\end{matrix}$$

Here, wₖ denotes a weight value for the k-th set in summation using k as the index, and p denotes an integer greater than or equal to 1. Variables such as K are substantially the same as those described above.

Next, vector representations of devices will be described with reference to the drawings while comparing with a comparative example. The comparative example is vector representations obtained using ConvE (NPL 4).

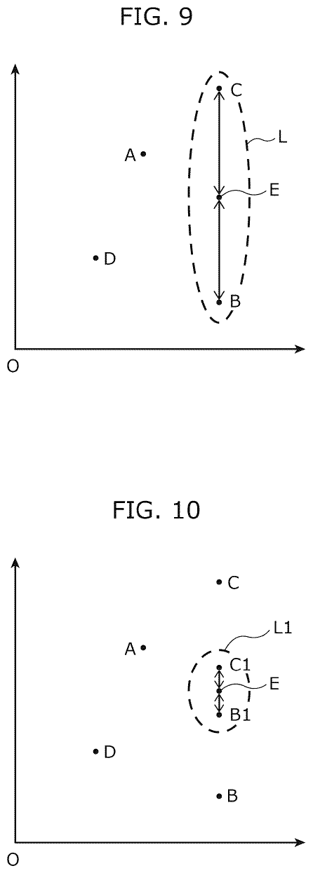

FIG. 9 is a diagram illustrating vector representations of devices according to the comparative example. FIG. 9 illustrates a vector space, and points in the vector space each indicate a vector from origin O to the point.

FIG. 9 illustrates, in the vector space, vectors A, B, C, and D that represent devices A, B, C, and D (that is, nodes A, B, C, and D illustrated in FIG. 6), respectively. Vectors A, B, C, and D in FIG. 9 are vector representations of devices A, B, C, and D obtained from communication triplets through the ConvE model; in other words, vectors A, B, C, and D in FIG. 9 are vectors representing devices A, B, C, and D.

In FIG. 9, vectors B and C are included in one cluster L. Cluster L indicates two or more vectors having a similar device relationship.

The reason why vectors B and C are included in cluster L is because devices B and C: are two devices included in the source devices indicated in the learning communication triplets; have A in common as the destination device information; and have HTTP in common as the communication type.

In FIG. 9, the distance from vector E to vector B and the distance from vector E to vector C are relatively large. Vector E is a vector representing the center position of the cluster (the center position of the vectors included in the cluster).

FIG. 10 is a diagram illustrating vector representations of devices according to the present embodiment. FIG. 10 illustrates a vector space as in FIG. 9.

As in FIG. 9, FIG. 10 illustrates, in the vector space, vectors A, B1, C1, and D that represent devices A, B, C, and D, respectively. Vectors A, B1, C1, and D in FIG. 10 are vector representations of devices A, B, C, and D converted from the learning communication triplets through model 302; in other words, vectors A, B1, C1, and D in FIG. 10 are vectors representing devices A, B, C, and D. FIG. 10 also illustrates vectors B and C illustrated in FIG. 9.

In FIG. 10, vectors B1 and C1 are included in one cluster L1. As with cluster L (see FIG. 9), cluster L1 indicates two or more vectors having a similar device relationship.

In FIG. 10, vectors B1 and C1 are positioned closer to each other than vectors B and C are in FIG. 9. Further, the distance from vector E to vector B1 and the distance from vector E to vector C1 are relatively small. More specifically, the distance from vector E to vector B1 in FIG. 10 is smaller than the distance from vector E to vector B in FIG. 9, and the distance from vector E to vector C1 in FIG. 10 is smaller than the distance from vector E to vector C in FIG. 9.

This is because learning unit 23 has trained model 302 by machine learning to bring closer to each other the vector representations, in the vector space, of two or more devices having a similar device relationship (that is, regularize similar devices).

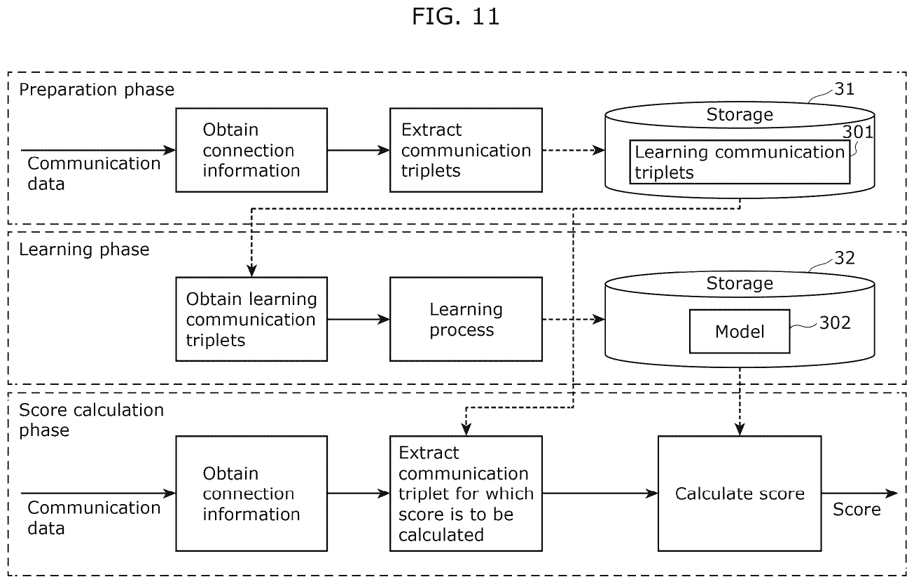

FIG. 11 is a diagram illustrating a framework of a process performed by anomaly determination system 100 according to the present embodiment. The same reference signs are assigned to constituent elements that are substantially the same as those in FIG. 1 and FIG. 2. As illustrated in FIG. 11, the process performed by anomaly determination system 100 includes a preparation phase, a learning phase, and a score calculation phase.

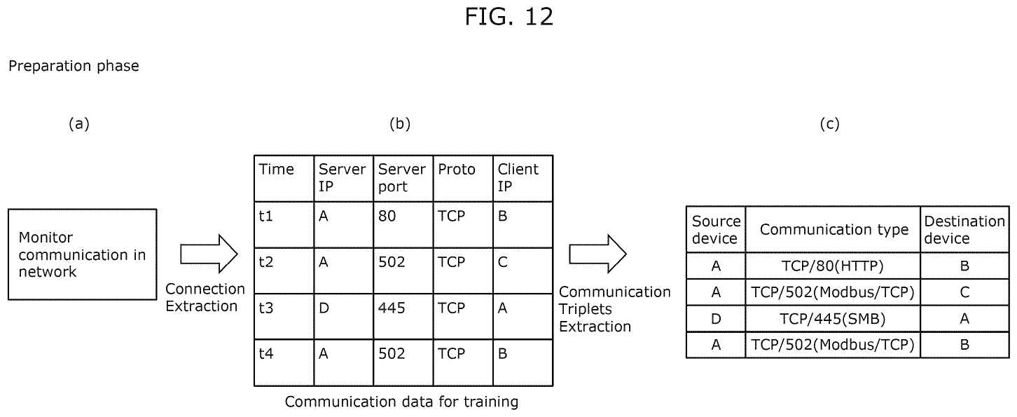

FIG. 12 is a diagram conceptually illustrating one example of a process performed in the preparation phase by anomaly determination system 100 according to the present embodiment.

As illustrated in (a) of FIG. 12, anomaly determination system 100 monitors communication in a network (for example, the ICS network), and obtains connection information from a mirror packet group in the communication in the network. The mirror packet group corresponds to a learning packet group.

As illustrated in (b) of FIG. 12, the connection information includes, for example, information indicating, for each mirror packet, a time of transmission, a server IP (the IP address of a server), the port number of a server, a protocol, and a client IP (the IP address of a client).

Note that when some of the devices in a monitoring target network are permitted to communicate with the Internet via a gateway, the connection information includes the IP addresses of various devices on the Internet. In that case, anomaly determination system 100 excludes devices located outside the monitoring target network, so as to obtain connection information of one or more devices located inside the monitoring target network.

Note that the reason why the port number of a client is not included in the connection information is because the client arbitrarily determines the port number of the client for each connection.

Next, anomaly determination system 100 extracts communication triplets from the connection information obtained (see (c) of FIG. 12). Note that anomaly determination system 100 stores four communication triplets illustrated in (c) of FIG. 12 in storage 31 as learning communication triplets 301.

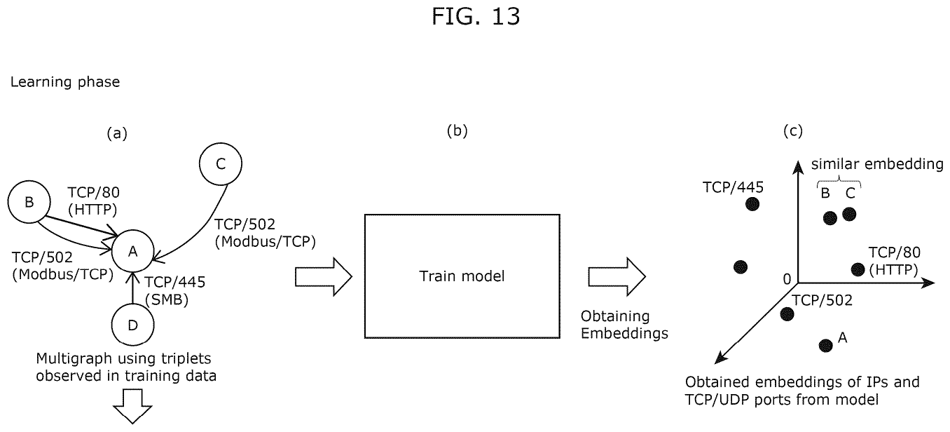

FIG. 13 is a diagram conceptually illustrating one example of a process performed in the learning phase by anomaly determination system 100 according to the present embodiment.

Anomaly determination system 100 obtains learning communication triplets 301 from storage 31 and performs a learning process on model 302 using learning communication triplets 301.

More specifically, first, anomaly determination system 100 obtains learning communication triplets 301 illustrated in (c) of FIG. 12 and constructs the multigraph illustrated in (a) of FIG. 13 from learning communication triplets 301 obtained.

Next, as illustrated in (b) of FIG. 13, anomaly determination system 100 trains model 302. Specifically, anomaly determination system 100 constructs the multigraph illustrated in (a) of FIG. 13, and trains model 302 to acquire vector representations of devices by mapping each node of the multigraph to a vector representation. In this training, anomaly determination system 100 causes model 302 to acquire vector representations of learning communication triplets 301 to regularize similar devices. Note that the vector representations of communication triplets are also generally called embeddings.

In such a manner, anomaly determination system 100 causes model 302 to acquire vector representations by mapping each node of the multigraph of learning communication triplets 301 to the vector space as illustrated in (c) of FIG. 13.

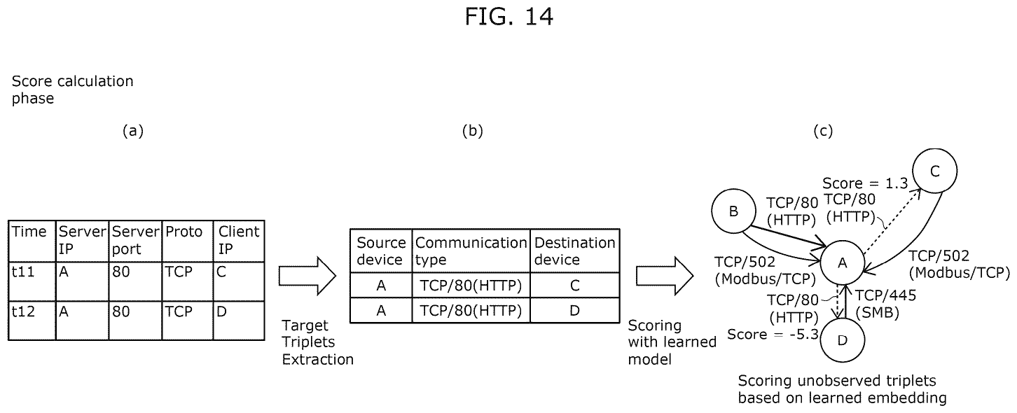

FIG. 14 is a diagram conceptually illustrating one example of a process performed in the score calculation phase by anomaly determination system 100 according to the present embodiment.

Anomaly determination system 100 monitors communication in the network, and obtains connection information illustrated in (a) of FIG. 14 from a mirror packet group in the communication in the network. The mirror packet group corresponds to an analysis target packet group.

Next, anomaly determination system 100 extracts, from the connection information obtained, communication triplets (A, TCP/80, C) and (A, TCP/80, D) illustrated in (b) of FIG. 14, as analysis target communication triplets. Note that TCP/80 means port 80 of TCP, which is generally synonymous with HTTP.

Next, anomaly determination system 100 converts the two analysis target communication triplets illustrated in (b) of FIG. 14 into edges in the multigraph. The edges obtained through the conversion are shown with dashed lines in (c) of FIG. 14. Furthermore, anomaly determination system 100 performs the score calculation process on the two analysis target communication triplets. As illustrated in (c) of FIG. 14, the score calculated for communication triplet (A, TCP/80, C) is 1.3, whereas the score calculated for communication triplet (A, TCP/80, D) is −5.3.

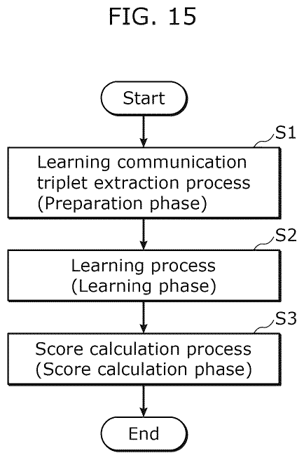

FIG. 15 is a flow diagram illustrating processes performed by anomaly determination system 100 according to the present embodiment.

As illustrated in FIG. 15, anomaly determination system 100 performs a learning communication triplet extraction process in step S1. Note that the learning communication triplet extraction process in step S1 corresponds to the process in the preparation phase described above.

In step S2, anomaly determination system 100 performs a learning process. Note that the learning process in step S2 corresponds to the process in the learning phase described above.

In step S3, anomaly determination system 100 performs a score calculation process. Note that the score calculation process in step S3 corresponds to the process in the score calculation phase described above.

Hereinafter, each process will be described in detail.

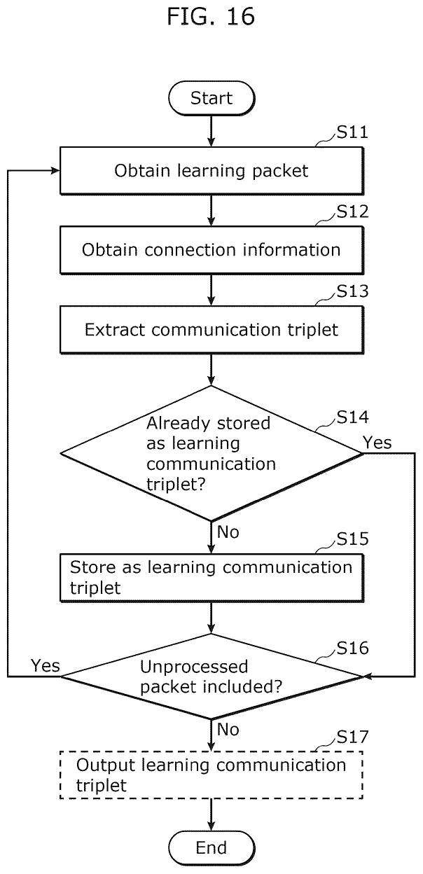

FIG. 16 is a flow diagram illustrating the learning communication triplet extraction process performed by anomaly determination system 100 according to the present embodiment. The process illustrated in FIG. 16 is a detailed process included in step S1 of FIG. 15, and can also be said to be a process performed by learning device 2.

In step S11, anomaly determination system 100 obtains a learning packet. Anomaly determination system 100 obtains one learning packet included in, for example, a mirror packet group (that is, a learning packet group) in communication in a network such as the ICS network. The learning packet obtained by anomaly determination system 100 is a learning packet on which the process in step S11 is not yet performed.

In step S12, anomaly determination system 100 obtains connection information from the learning packet obtained in step S11. The connection information includes information indicating: a server IP address; information indicating TCP or UDP and the port number of a server; and a client IP address.

In step S13, anomaly determination system 100 extracts a communication triplet from the connection information obtained in step S12.

In step S14, anomaly determination system 100 determines whether the communication triplet extracted in step S13 is already stored as learning communication triplet 301. If it is determined that the communication triplet is already stored as learning communication triplet 301 (Yes in step S14), the process proceeds to step S16, and if not (No in step S14), the process proceeds to step S15.

In step S15, anomaly determination system 100 stores in storage 31 the communication triplet extracted in step S13, as learning communication triplet 301.

In step S16, anomaly determination system 100 determines whether the learning packets included in the learning packet group include a packet on which the process in step S11 is not yet performed (also referred to as an unprocessed packet). If it is determined that an unprocessed packet is included (Yes in step S16), the process proceeds to step S11, and if not (No in step S16), the process proceeds to step S17.

In step S17, anomaly determination system 100 outputs learning communication triplet 301 stored in storage 31 in step S15. Note that the process in step S17 is not essential.

With the series of processes illustrated in FIG. 16, anomaly determination system 100 extracts a learning communication triplet from the learning packet group.

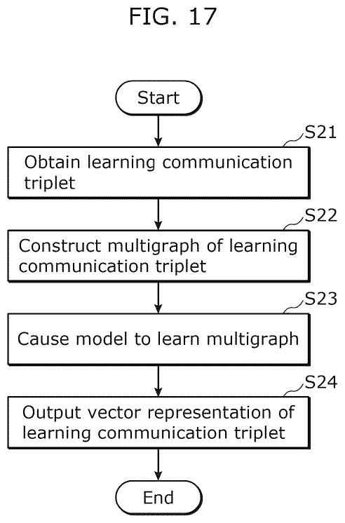

FIG. 17 is a flow diagram illustrating the learning process performed by anomaly determination system 100 according to the present embodiment. The process illustrated in FIG. 17 is a detailed process included in step S2 of FIG. 15, and can also be said to be a process performed by learning device 2.

In step S21, anomaly determination system 100 obtains learning communication triplet 301. Learning communication triplet 301 obtained by anomaly determination system 100 is learning communication triplet 301 stored in storage 31 through the process in step S1.

In step S22, anomaly determination system 100 constructs a multigraph of learning communication triplet 301 obtained in step S21.

In step S23, anomaly determination system 100 causes model 302 to learn the multigraph constructed in step S22. Anomaly determination system 100 causes model 302 to learn the structure of the multigraph constructed in step S22 and acquire a vector representation of learning communication triplet 301 by mapping each node of the constructed multigraph to a vector representation.

In step S24, anomaly determination system 100 outputs the vector representation of learning communication triplet 301 acquired through the learning in step S23.

With the series of processes illustrated in FIG. 17, anomaly determination system 100 outputs vector representations of devices indicated in learning communication triplet 301.

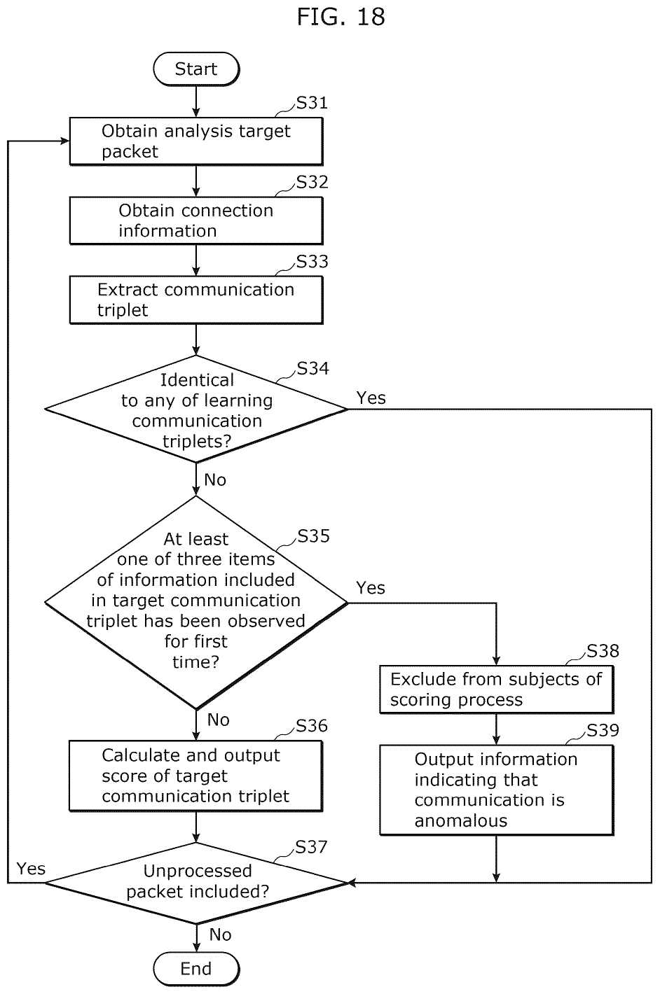

FIG. 18 is a flow diagram illustrating the score calculation process performed by anomaly determination system 100 according to the present embodiment. The process illustrated in FIG. 18 is a detailed process included in step S3 of FIG. 15, and can also be said to be a process performed by anomaly determination device 1.

In step S31, anomaly determination system 100 obtains an analysis target packet. Anomaly determination system 100 obtains one analysis target packet included in, for example, a mirror packet group (that is, an analysis target packet group) in communication in a network such as the ICS network. The analysis target packet obtained by anomaly determination system 100 is an analysis target packet on which the process in step S31 is not yet performed.

In step S32, anomaly determination system 100 obtains connection information from the analysis target packet obtained in step S31. Anomaly determination system 100 obtains, from the analysis target packet obtained in step S31, connection information that includes information indicating: a server IP address; information indicating TCP or UDP and the port number of a server; and a client IP address.

In step S33, anomaly determination system 100 extracts a communication triplet from the connection information obtained in step S32.

In step S34, anomaly determination system 100 determines whether the communication triplet extracted in step S33 is identical to any of learning communication triplets 301 stored in storage 31. If it is determined that the communication triplet is identical to any of learning communication triplets 301 (Yes in step S34), the process proceeds to step S37, and if not (in other words, if it is determined that the communication triplet extracted in step S33 is not identical to any of learning communication triplets 301 stored in storage 31) (No in step S34), the process proceeds to step S35.

In step S35, anomaly determination system 100 determines whether at least one of the three items of information included in the communication triplet extracted in step S33 has been observed for the first time. The case where at least one of the three items of information included in the extracted communication triplet has been observed for the first time is the case where the at least one of the three items of information is not included in learning communication triplets 301. If it is determined that at least one of the three items of information included in the communication triplet has been observed for the first time (Yes in step S35), the process proceeds to step S38, and if not (No in step S35), the process proceeds to step S36.

In step S36, anomaly determination system 100 calculates a score of the communication triplet extracted in step S33, and outputs the score calculated.

In step S38, anomaly determination system 100 performs a process of excluding, from the subjects of the score calculation, the communication triplet extracted in step S33.

In step S39, anomaly determination system 100 outputs information indicating that communication in the communication triplet extracted in step S33 is anomalous.

In step S37, anomaly determination system 100 determines whether the learning packets included in the learning packet group include a packet on which the process in step S31 is not yet performed (also referred to as an unprocessed packet). If it is determined that an unprocessed packet is included (Yes in step S37), the process proceeds to step S31, and if not (No in step S37), the series of processes illustrated in FIG. 18 ends.

With the series of processes illustrated in FIG. 18, anomaly determination system 100 calculates and outputs the score of the analysis target packet.

### Working Example

Since the effectiveness of model 302 according to the above embodiment has been verified, the result of experiments that have verified the effectiveness will be described as a working example.

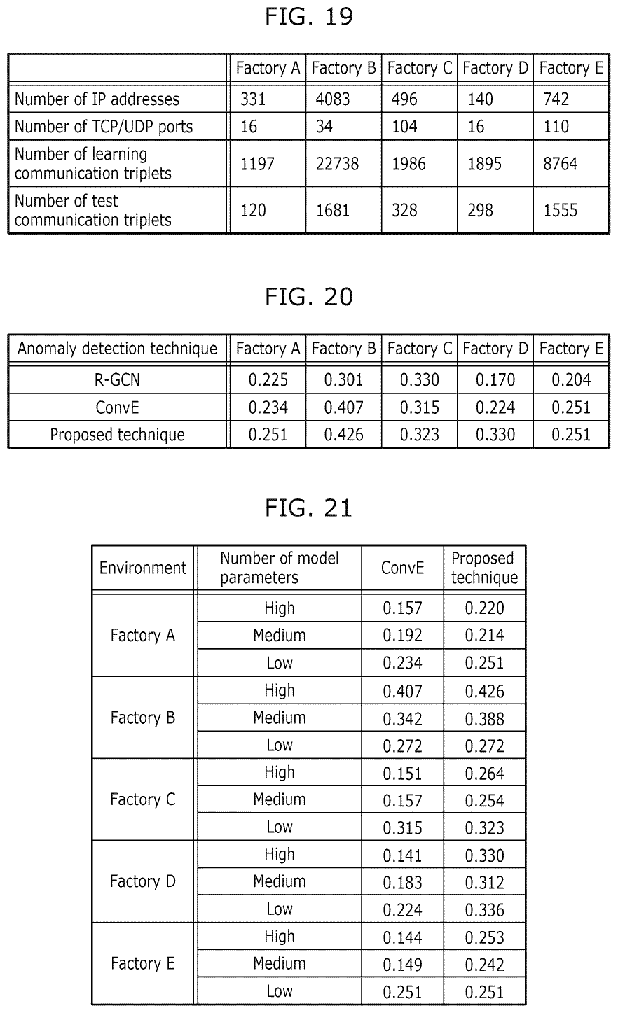

FIG. 19 is a diagram illustrating the characteristics of a dataset according to the present working example.

The dataset illustrated in FIG. 19 is a dataset obtained from communication in the ICS network in five factories A, B, C, D, and E. Installed facilities, communication protocols, and network configurations are different from factory to factory.

Packets in the ICS network used in the five factories A through E were independently collected for two weeks each, using a mirror port of an L2 switch. In these five factories, not only such protocols as Modbus and Ethernet/IP, but also such protocols as NetBIOS, DNS, HTTP, HTTPS, FTP, SMB, RDP, SSH, and MSSQL were observed. Among the packets collected, only unicast communications excluding multicast and broadcast communications were subjected to the learning process and the score calculation process.

The numbers of IP addresses illustrated in FIG. 19 were obtained by counting, for each of the five factories, the number of IP addresses that have emerged in communication in the ICS network at the factory in a specific one week (also referred to as a first week). The same applies to the numbers of TCP/UDP ports and the numbers of learning communication triplets.

Test communication triplets illustrated in FIG. 19 were obtained one week after the first week (also referred to as a second week). Note that among communication triplets obtained in the second week, communication triplets included in the learning communication triplets were excluded from the test communication triplets. Furthermore, communication triplets having unobserved IP addresses or TCP/UDP port numbers were also excluded from the test communication triplets.

FIG. 20 is a diagram illustrating a first example of evaluation values for anomaly detection techniques according to the present working example and comparative examples.

FIG. 20 illustrates evaluation values obtained when a relational graph convolutional network (R-GCN), ConvE, and the proposed technique were each used as an anomaly detection technique. The R-GCN and ConvE are anomaly detection techniques according to comparative examples and the proposed technique is an anomaly detection technique according to the present working example.

Mean reciprocal rank (MRR) was used as the evaluation value. MRR is a measure used in evaluating an algorithm that assigns, to all samples, a score used for calculating the relevance to a query, and is calculated using the average of reciprocal ranks (also called rankᵢ) for a given query (see Expression 5). Note that the MRR is expressed as 0≤MRR≤1, and the closer the MRR is to 1, the higher the performance is.

$$\begin{matrix}[ Math . 11 ] & \\ MRR = \frac{1}{\vert Q \vert} {\sum }_{i = 1}^{\vert Q \vert} \frac{1}{{rank}_{i}} & Expression 5\end{matrix}$$

Specifically, the case where communication triplet (s, p, d) is subjected to rank calculation will be described as an example.

In this case, scores are calculated for communication triplets (s′, p, d) in the case where a plurality of devices including source device s are tentatively called source devices s′, and a rank (also referred to as ranks) of, among the plurality of scores calculated, the score of communication triplet (s, p, d) is calculated.

Similarly, scores are calculated for communication triplets (s, p, d′) in the case where a plurality of devices including destination device d are tentatively called destination devices d′, and a rank (also referred to as rank_{d}) of, among the plurality of scores calculated, the score of communication triplet (s, p, d) is calculated.

When a total number of communication triplets subjected to rank calculation is |Q|, ranks and rank_{d} are vectors in |Q| dimensions. The i-th element rankᵢ of the average vector (|Q| dimensional vector) of vector ranks and vector rank_{d} is used as the rank for the i-th communication triplet among |Q| communication triplets, and MRR is calculated.

As illustrated in FIG. 20, in many of the factories (specifically, factories A, B, D, and E), the evaluation value for ConvE is higher than the evaluation value for R-GCN; in other words, the evaluation value for ConvE is closer to 1. This suggests that information on link orientation used by ConvE can have a positive effect on link prediction performance.

Also, in all the factories, the evaluation value for the proposed technique is higher than the evaluation value for ConvE. This indicates that regularization of similar devices can improve the performance.

FIG. 21 is a diagram illustrating a second example of evaluation values for anomaly detection techniques according to the present working example and a comparative example.

FIG. 21 illustrates differences in performance according to whether or not similar devices are regularized when the number of model parameters is varied.

ConvE exhibits a relatively large change in performance in accordance with the number of model parameters, whereas the proposed technique exhibits a relatively small change in performance in accordance with the number of model parameters.

This indicates that regularization of similar devices increases the robustness of link prediction, making it possible to inhibit model overfitting and maintain high prediction performance even when a somewhat large number of model parameters is set.

Note that each of the constituent elements in the above embodiment may be configured in the form of an exclusive hardware product, or may be realized by executing a software program suitable for the constituent element. Each of the constituent elements may be realized by means of a program executing unit, such as a CPU and a processor, reading and executing the software program recorded on a recording medium such as a hard disk or a semiconductor memory. Here, the software program for realizing the anomaly determination system and the like according to the above embodiment is a program described below.

That is, the program causes a computer to execute an anomaly determination method including: extracting a first communication triplet indicating source device information, destination device information, and type information of a first communication packet that has flowed in a network; calculating, by inputting the first communication triplet into a trained model, a score indicating a probability that the first communication packet is predicted to flow in the network; and determining, using the score calculated, a degree of how anomalous it is for the first communication packet to flow in the network, and outputting the degree determined, wherein the trained model is trained by machine learning to: (1) by using a vector representation of source device information or destination device information of a communication packet and type information of the communication packet, calculate, as a score, a probability that the first communication triplet is predicted to be present under presence of a plurality of second communication triplets each indicating a second communication packet that has previously flowed in the network; and (2) make the vector representation a vector representation that represents two or more devices as vectors closer to each other in a vector space, the two or more devices being (i) either source devices or destination devices indicated in the plurality of second communication triplets and (ii) indicated in learning communication triplets having communication partner device information in common and a communication type in common.

Hereinbefore, an anomaly determination system according to one or more aspects has been described based on an exemplary embodiment, but the present disclosure is not limited to this embodiment. Various modifications of the present embodiment as well as forms resulting from combinations of constituent elements in different embodiments that may be conceived by those skilled in the art may be included within the scope of one or more aspects so long as such modifications and forms do not depart from the essence of the present disclosure.

### INDUSTRIAL APPLICABILITY

The present disclosure is applicable to a communication monitoring system that monitors communication in a network.

1. An anomaly determination method comprising:
extracting a first communication triplet indicating source device information, destination device information, and type information of a first communication packet that has flowed in a network;
calculating, by inputting the first communication triplet into a trained model, a score indicating a probability that the first communication packet is predicted to flow in the network; and
determining, using the score calculated, a degree of how anomalous it is for the first communication packet to flow in the network, and outputting the degree determined, wherein
the trained model is trained by machine learning to:
(1) by using a vector representation of source device information or destination device information of a communication packet and type information of the communication packet, calculate, as a score, a probability that the first communication triplet is predicted to be present under presence of a plurality of second communication triplets each indicating a second communication packet that has previously flowed in the network; and
(2) make the vector representation a vector representation that represents two or more devices as vectors closer to each other in a vector space, the two or more devices being (i) either source devices or destination devices indicated in the plurality of second communication triplets and (ii) indicated in learning communication triplets having communication partner device information in common and a communication type in common.

2. The anomaly determination method according to claim 1, wherein
the trained model is a model trained by the machine learning using, as a loss function, a sum of a first function and a second function,
the first function includes a loss function included in a link prediction method by which a probability that the first communication triplet is predicted to be present under presence of the plurality of second communication triplets is calculated as a score using machine learning, and
the second function includes a sum total of distances between (i) an average vector that is an average of the vectors that represent each of the two or more devices and (ii) each of the vectors that represent each of the two or more devices.

3. The anomaly determination method according to claim 2, wherein
the loss function denoted by L is expressed as
$$L = {L}_{1} + a \times {L}_{2}$$
where L₁ denotes the first function,
L₂ denotes the second function, and
α denotes a hyper parameter.

4. The anomaly determination method according to claim 3, wherein
the second function denoted by L₂ is expressed as
$$\begin{matrix}[ Math . 1 ] \\ {L}_{2} = {\sum }_{k = 1}^{K} {\sum }_{i = 1}^{{n}_{k}} {‖ {x}_{k}^{( i )} - {c}_{k} ‖}^{2} \\ where \\ [ Math . 2 ] \\ {c}_{k} = \frac{( {x}_{k}^{( 1 )} + ⋯ + {x}_{k}^{( {n}_{k} )} )}{{n}_{k}}\end{matrix}$$
K denotes a total number of sets of the communication partner device information and the type information,
nₖ denotes a total number of devices included in a k-th set among the sets, and
$$\begin{matrix}[ Math . 3 ] & \\ {x}_{k}^{( i )} & \end{matrix}$$
denotes a vector representing an i-th device included in the k-th set.

5. The anomaly determination method according to claim 3, wherein
the second function denoted by L₂ is expressed as
$$\begin{matrix}[ Math . 4 ] & \\ {L}_{2} = {\sum }_{k = 1}^{K} {{w}_{k} ( {\sum }_{i = 1}^{{n}_{k}} {‖ {x}_{k}^{( i )} - {c}_{k} ‖}^{p} )}^{\frac{1}{p}} \\ where & \\ [ Math . 5 ] & \\ {c}_{k} = \frac{( {x}_{k}^{( 1 )} + ⋯ + {x}_{k}^{( {n}_{k} )} )}{{n}_{k}} & \end{matrix}$$
K denotes a total number of sets of the communication partner device information and the type information,
wₖ denotes a weight value for a k-th set among the sets,
nₖ denotes a total number of devices included in the k-th set,
$$\begin{matrix}[ Math . 6 ] & \\ {x}_{k}^{( i )} & \end{matrix}$$
denotes a vector representing an i-th device included in the k-th set, and
p denotes an integer greater than or equal to 1.

6. The anomaly determination method according to claim 2, wherein
the link prediction method is convolutional 2d knowledge graph embeddings (ConvE).

7. The anomaly determination method according to claim 1, wherein
the source device information is a source IP address of the communication packet,
the destination device information is a destination IP address of the communication packet, and
the type information indicates (i) information indicating a transmission control protocol (TCP) or a user datagram protocol (UDP) of the communication packet and (ii) a port number of the communication packet.

8. An anomaly determination system comprising:
an extractor that extracts a first communication triplet indicating source device information, destination device information, and type information of a first communication packet that has flowed in a network;
a that calculates, by inputting the first calculator communication triplet into a trained model, a score indicating a probability that the first communication packet is predicted to flow in the network; and
a determiner that determines, using the score calculated by the calculator, a degree of how anomalous it is for the first communication packet to flow in the network, and outputs the degree determined, wherein
the trained model is trained by machine learning to:
(a) by using a vector representation of source device information or destination device information of a communication packet and type information of the communication packet, calculate, as a score, a probability that the first communication triplet is predicted to be present under presence of a plurality of second communication triplets each indicating a second communication packet that has previously flowed in the network; and
(b) make the vector representation a vector representation that represents two or more devices as vectors closer to each other in a vector space, the two or more devices being (i) either source devices or destination devices indicated in the plurality of second communication triplets and (ii) indicated in learning communication triplets having communication partner device information in common and a communication type in common.

9. A non-transitory computer-readable recording medium having recorded thereon a program for causing a computer to execute the anomaly determination method according to claim 1.
